(19) United States
(12) Patent Application Publication
(10) Pub. No.: US 2023/0278110 A1
(43) Pub. Date: Sep. 7, 2023

(54) DRILL CHUCK

(71) Applicant: Roehm GmbH, Sontheim/Brenz (DE)

(72) Inventors: Peter SCHENK, Niederstotzingen (DE); Fabian MAYERLE, Blindheim (DE)

(73) Assignee: Roehm GmbH, Sontheim/Brenz (DE)

(21) Appl. No.: 18/197,510

(22) Filed: May 15, 2023

Related U.S. Application Data
(63) Continuation of application No. PCT/EP2021/077700, filed on Oct. 7, 2021.

(30) Foreign Application Priority Data
Dec. 1, 2020 (DE) 10 2020 131 833.2

(51) Int. Cl. B23B 31/12

(52) U.S. Cl. CPC B23B 31/123; B23B 31/1253

(57) ABSTRACT

A drill chuck having a chuck body connectable to a drill spindle, in which clamping jaws are arranged in guide receptacles which run at an incline to the chuck axis and, for the purpose of opening and closing, are adjustable by a threaded ring arranged so as to be rotatable and axially immovable with respect to the chuck body. A locking device, which is made up of a coaxial circle of locking recesses and of at least one locking member, is engaged with the locking recesses under the force of a locking spring. A locking adjusting, is rotatable to a limited extent between end stops and whose rotation allows the locking member to be adjusted. A latching device forms two latching positions in the circumferential direction. A dampener is arranged between the adjusting sleeve and the component adjacent thereto radially to the inside.

This nonprovisional application is a continuation of International Application No PCT/EP2021/077700, which was filed on Oct. 7, 2021, and which claims priority to German Patent Application No 10 2020 131 833.2, which was filed in Germany on Dec. 1, 2020, and which are both herein incorporated by reference.

### BACKGROUND OF THE INVENTION

### Field of the Invention

The invention relates to a drill chuck, including a chuck body connectable to a drill spindle, in which clamping jaws are arranged in guide receptacles, which run at an incline to the chuck axis and, for the purpose of opening and closing, are adjustable by a threaded ring, which is arranged so as to be rotatable and axially immovable with respect to the chuck body, including a locking device, which is made up of a coaxial circle of locking recess and at least one locking member, which is engageable or engaged with the locking recesses under the force of a locking spring, including an adjusting sleeve, which is rotatable to a limited extent between end stops and the rotation of which allows the locking member to be adjusted, and including a latching device which forms two latching positions in the circumferential direction, a dampener being arranged between the adjusting sleeve and the component adjacent thereto radially on the inside.

### Description of the Background Art

Drill chucks are known from EP 0 710 518 A2, which corresponds to US5765839, which is incorporated herein by reference, and in which, in particular, the structure of the interlock device formed from the locking device and the latching device, as well as its operation in interaction with the individual components, is described. Drill chucks of this type have proven to be extremely successful in practice.

In the conventional art, however, greater demands are imposed on the interlocking system by the higher power of modern drilling machines, and it must also be ensured that the interlocking system remains closed even if very strong vibrations occur during percussion drilling or when operating a screw coupler. The abrupt lag of the spindle when using a spindle stop should also not be able to loosen the interlocking system.

### SUMMARY OF THE INVENTION

It is therefore an object of the invention to further improve the proven and perfected drill chuck of the type mentioned at the outset.

The arrangement of a dampener between the adjusting sleeve and the component adjacent thereto radially to the inside achieves the fact that the torque needed to deactivate the interlocking device is increased, so that the occurring vibrations are not sufficient to disengage the locking member from the locking toothings.

The dampener can be arranged between the adjusting sleeve and an intermediate sleeve, since, in the case that the dampener is arranged between the adjusting sleeve and the chuck body, an increased torque is needed continuously to adjust the clamping jaws, and, in particular, the achievable clamping force may thus be impaired.

The dampener can be arranged in a groove running in the circumferential direction of the adjusting sleeve, the dampener being accommodated in this groove at a distance from a base thereof.

The drill chuck is easier to mount if the dampener is arranged in the region of the largest diameter of the component adjacent to the adjusting sleeve radially to the inside.

It has proven to be successful if the dampener is formed by an elastic O ring, so that the dampener may also be easily pretensioned, due to the expansion in the groove suitably designed for this purpose by means of the component situated radially to the inside.

The design of the groove is simplified, in particular, if the adjusting sleeve is provided with a two-part design, formed from an outer metallic grip sleeve and an inner plastic sleeve, which provides a radial cam and end stops and in which the groove is formed.

The features and combinations of features mentioned in the description above as well as the features and combination of features mentioned below in the description of the figures and/or illustrated in the figures alone may be used not only in the particular combination given but also in other combinations or alone without departing from the scope of the invention. Embodiments are thus also to be viewed as covered and disclosed by the invention which are not explicitly illustrated in the figures or explained but which arise from the explained designed and may be generated, due to separate combinations of features.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side view of the drill chuck, illustrated as a longitudinal section in the left half;

FIG. 2 shows section II-II from FIG. 1;

FIG. 3 shows section III-III from FIG. 1; and

FIG. 4 shows a longitudinal section of the isolated clamping sleeve, including the dampener.

### DETAILED DESCRIPTION

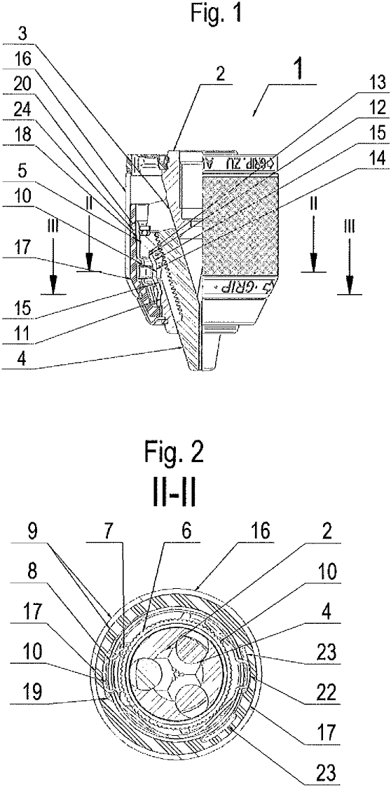

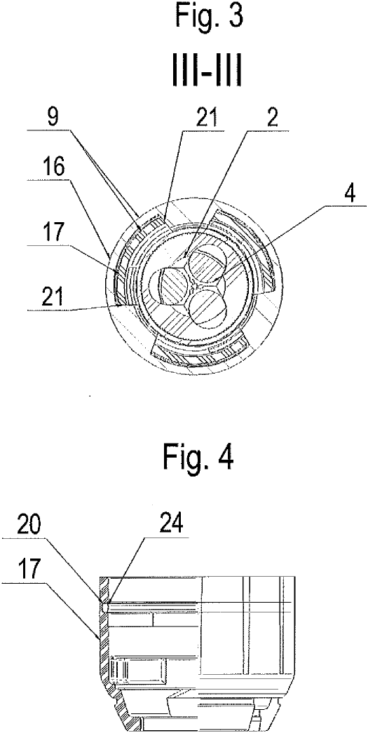

It is apparent from FIG. 1 that drill chuck 1 includes a chuck body 2, connectable to a drill spindle, in which clamping jaws 4, which are accommodated in guide receptacles 3 running at an incline to the chuck axis and which, for the purpose of opening and closing, are adjustable by a threaded ring 5 arranged such that it is rotatable and axially immovable with respect to chuck body 2. To prevent undesirable adjustments of clamping jaws 4, the rotational position of threaded ring 5 may be fixed. A locking device formed between threaded ring 5 and chuck body 2 is used for this purpose, which is made up of a coaxial circle 6 of locking recesses on the side of chuck body 2 and of at least one locking member 7 on the side of threaded ring 5, which engages with the locking recesses with the force of a locking spring 8. Locking member 7 and the locking recesses accommodating it, abut each other in edge surfaces which are inclined in such a way that they lock threaded ring 5 against rotation in the rotational direction corresponding to the opening of drill chuck 1, and when threaded ring 5 is rotated by hand with a sufficiently high torque for this purpose in the opposite rotational direction, i.e., corresponding to the closing of drill chuck 1, locking member 7, however, is pressed out of the locking recesses against the spring force, and is able to slide along the circumference of chuck body 2. Locking member 7 may be adjusted between its states engaged and disengaged with the locking recesses, for which purpose locking member 7 is adjustable by a radial cam 19 on a coaxial, also axially immovable, adjusting sleeve 9, and adjusting sleeve 9 is correspondingly rotatable relative to threaded ring 5. This rotation of adjusting sleeve 9 relative to threaded ring 5 is limited by end stops 21 in a form-fitting manner in both rotational directions. By rotating adjusting sleeve 9 in the rotational direction corresponding to the closing of drill chuck 1 locking member 7 moves out of the disengaged state into the engaged state and vice-versa. A latching device 22 is provided between adjusting sleeve 9 and threaded ring 5, which has two latching positions 23 in the circumferential direction, locking member 7 being in the state engaged with the locking recesses in the one latching position 23 and in the disengaged state in the other latching position 23. The functionality of an interlocking device of this type has long been known to those skilled in the art from EP 0 710 518 A2, which as noted above corresponds to US5765839 and which is incorporated herein by reference.

In the examples illustrated in the drawing, threaded ring 5 is formed as an undivided threaded ring having an opening width which is greater than the diameter of the axially front section of chuck body 2, a locking sleeve 10 being rotatably fixedly fastened in an axially immovable manner on the axially front section of chuck body 2, which carries circle 6 of locking recesses and is used to axially secure threaded ring 5. However, threaded ring 5 may also be designed as a divided threaded ring 5, and circle 6 of locking recesses may be formed directly on chuck body 2, as is also disclosed in EP 0 710 518 A2.

Locking sleeve 10 itself has a cylindrical front body section 11 as well as a rear conical section 12, which is provided for contact with an axially front annular band 13 of threaded ring 5. Locking sleeve 10 furthermore has a central section 14 running in parallel to the chuck axis, which carries circle 6 of locking recesses and is connected to front body section 11 and conical section 12 via section edges 15 running in parallel to guide receptacles 3.

It is also apparent from FIG. 1 that a dampener 24 is arranged between adjusting sleeve 9 and the component adjacent thereto radially to the inside, the dampener 24 in the example being arranged between adjusting sleeve 9 and an intermediate sleeve 18. Dampener 24 effectuates a damping of vibrations and prevents a loosening of the interlocking system, or makes it more difficult, if the holding force of locking spring 8 is less than the inertia of adjusting sleeve 9, i.e., if strong acceleration forces act upon adjusting sleeve 9, for example, when using a spindle stop.

Alternatively, it is also possible that dampener 24 is arranged between adjusting sleeve 9 and chuck body 2.

It is apparent from FIGS. 1 and 4 that dampener 24 is arranged in a groove 20 running in the circumferential direction of adjusting sleeve 9 and is accommodated therein at a distance from a base of groove 20. Dampener 24 is formed by an elastic O ring, which is pretensioned, which is permitted and made easier by the corresponding design of groove 20. Dampener 24 itself is arranged in the region of the largest diameter of the component adjacent to adjusting sleeve 9 radially to the inside, i.e., intermediate sleeve 18 in the example.

If adjusting sleeve 9 is provided with a two-part design, formed from an outer metallic grip sleeve 16, which is used to apply a high clamping force, and an inner plastic sleeve 17 providing radial cam 19 and end stops 21, it is easily possible to also provide groove 20 when forming the complex inner surface of plastic sleeve 17.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A drill chuck comprising:
a chuck body connectable to a drill spindle;
clamping jaws are arranged in guide receptacles of the chuck body, the clamping jaws running at an incline to the chuck axis and, for the purpose of opening and closing, are adjustable by a threaded ring arranged so as to be rotatable and axially immovable with respect to the chuck body;
a locking device comprising a coaxial circle of locking recesses and of at least one locking member, which is adapted to engage the locking recesses under a force of a locking spring;
an adjusting sleeve rotatable to a limited extent between end stops and whose rotation allows the locking member to be adjusted;
a latching device forming two latching positions in a circumferential direction; and
a dampener arranged between the adjusting sleeve and the component adjacent thereto radially to the inside.

2. The drill chuck according to claim 1, wherein the dampener is arranged between the adjusting sleeve and an intermediate sleeve.

3. The drill chuck according to claim 1, wherein the dampener is arranged between the adjusting sleeve and the chuck body.

4. The drill chuck according to claim 1, wherein the dampener is arranged in a groove running in the circumferential direction of the adjusting sleeve.

5. The drill chuck according to claim 4, wherein the dampener is accommodated in the groove at a distance from a base thereof.

6. The drill chuck according to claim 1, wherein the dampener is arranged in the region of the largest diameter of the component adjacent to the adjusting sleeve radially to the inside.

7. The drill chuck according to claim 1, wherein the dampener is formed by an elastic O-ring.

8. The drill chuck according to claim 1, wherein the dampener is pretensioned.

9. The drill chuck according to claim 1, wherein the adjusting sleeve is provided with a two-part design formed from an outer metallic grip sleeve and an inner plastic sleeve, which provides a radial cam and end stops.

10. The drill chuck according to claim 9, wherein the groove is provided in the plastic sleeve.
